(19) United States
(12) Patent Application Publication
(10) Pub. No.: US 2022/0075035 A1
(43) Pub. Date: Mar. 10, 2022

(54) BEAM STEERING IN FREQUENCY-MODULATED CONTINUOUS WAVE (FMCW) LIDAR SYSTEMS

(71) Applicant: Nuro, Inc., Mountain View, CA (US)

(72) Inventors: Zhanwei Liu, Fremont, CA (US); Yun Zhang, San Jose, CA (US); Hao Li, San Jose, CA (US)

(21) Appl. No.: 17/462,576

(22) Filed: Aug. 31, 2021

Related U.S. Application Data
(60) Provisional application No. 63/076,710, filed on Sep. 10, 2020.
(60) Provisional application No. 63/163,424, filed on Mar. 19, 2021.

(51) Int. Cl. G01S 7/481; G01S 17/32; G01S 7/4911; G01S 17/931

(52) U.S. Cl. CPC G01S 7/4817; G01S 17/32; G01S 17/931; G01S 7/4818; G01S 7/4911

(57) ABSTRACT

According to one aspect, a coherent lidar system such as a Frequency-Modulated Continuous Wave (FMCW) lidar system may be provided with a beam steering or scanning arrangement which provides three-dimensional scanning. By providing a beam steering or scanning arrangement which provides an approximately 360 degree range of horizontal scanning, and an approximately twenty degree range of vertical scanning, an FMCW lidar system may achieve a scanning field of view that is similar to that of Time-of-Flight (TOF) lidar systems. A FMCW lidar system with three-dimensional scanning may enable fewer FMCW lidar systems to be used to provide a desired overall scanning field of view, and also achieve a comparable overall scanning field of view as a TOF lidar system substantially without issues such as the significant movement of electrical components.

### CROSS-REFERENCE TO RELATED APPLICATIONS

This application claims priority to U.S. Provisional Application No. 63/076,710, filed Sep. 10, 2020, and to U.S. Provisional Application No. 63/163,424, filed Mar. 19, 2021. The entirety of each of these applications is incorporated herein by reference.

### TECHNICAL FIELD

The disclosure relates to autonomous vehicles. More particularly, the disclosure providing light detection and ranging (lidar) systems for use in autonomous vehicles.

### BACKGROUND

Light detection and ranging (lidar) is a technology that is often used to measure distances from an object to a remote target. For example, many autonomous vehicles utilize lidar. In general, a lidar system includes a light source and a detector. The light source emits light that is scattered by a target, and the scattered light is returned, or received, by the detector. Based on characteristics associated with the received light, the lidar system determines a distance from the lidar system to the target.

In lidar systems, there is often a trade-off between performance and cost. As the use of lidar grows, the need for improved, high performing, and relatively low-cost lidar systems is also growing.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram of a lidar system in accordance with an example embodiment.

FIG. 5A is a diagrammatic representation of a lidar system with a horizontal scanning range and a vertical scanning range in accordance with an example embodiment.

FIG. 5B is a diagrammatic representation of a lidar system having multiple lidar sensors each of which covers a portion of a 360 degree horizontal scanning range, according to an example embodiment.

FIG. 6 is a diagrammatic representation of a beam steering arrangement of a Frequency-Modulated Continuous Wave (FMCW) lidar system that includes a mirror and a plane light-wave circuit (PLC) in accordance with an embodiment.

FIG. 7 is a diagrammatic representation of a beam steering arrangement of a FMCW lidar system that includes a mirror and a diffractive optical element (DOE) in accordance with an embodiment.

FIG. 8 is a diagrammatic representation of a beam steering arrangement of a FMCW lidar system that includes a prism mirror in accordance with an embodiment.

FIG. 9 is a diagrammatic representation of a beam steering arrangement of a FMCW lidar system that includes a right-angle mirror in accordance with an embodiment.

FIG. 10 is a diagrammatic representation of a beam steering arrangement of a FMCW lidar system that includes a polygonal mirror in accordance with an embodiment.

FIG. 11 is a diagram of an irregular polygon with multiple faces each at different tilt angles to achieve a horizontal scanning field of view and a vertical scanning field of view, such as in the beam steering arrangement depicted in FIG. 10.

FIG. 12 shows a beam steering arrangement having a galvanometer (Galvo) mirror and a polygon mirror configured to provide a horizontal scanning field of view and a vertical scanning field of view, according to an example embodiment.

FIG. 13 is a block diagram of a beam steering arrangement including multiple polygon mirrors with different angled faces and multiple light sources, according to an example embodiment.

FIG. 14 is a diagram of a lidar system having a beam steering arrangement that includes a splitter and circulator arrangement, according to an example embodiment.

FIG. 15 is a block diagram of representation of a splitter and circulator arrangement that may be used in the lidar system of FIG. 14, in accordance with an embodiment.

FIGS. 16A and 16B are side-view representations of lens arrangements that may be used in the splitter and circulator arrangement of FIG. 14, according to an example embodiment.

FIG. 17 is a diagrammatic representation of a lidar system that includes a splitter and circular arrangement and a rotating polygon mirror, according to an example embodiment.

FIG. 18 is a block diagram of a lidar system employing a beam splitting arrangement to generate multiple output beams, according to an example embodiment.

FIG. 19 is a flow chart depicting a method for perform scanning of light beams in a horizontal field of view and a vertical field of view, according to an example embodiment.

FIG. 20 is a block diagram of a computing apparatus that may be configured to perform various control and signal analysis operations in a lidar system, according to an example embodiment.

### DESCRIPTION OF EXAMPLE EMBODIMENTS

### General Overview

In one embodiment, a coherent lidar system such as a Frequency-Modulated Continuous Wave (FMCW) lidar system may be provided with a beam steering or scanning arrangement which provides three-dimensional scanning. By providing a beam steering or scanning arrangement which provides an approximately 360 degree range of horizontal scanning, and an approximately twenty degree range of vertical scanning, an FMCW lidar system may achieve a scanning field of view that is similar to that of Time-of-Flight (TOF) lidar systems. A FMCW lidar system with three-dimensional scanning may enable fewer FMCW lidar systems to be used to provide a desired overall scanning field of view, and also achieve a comparable overall scanning field of view as a TOF lidar system substantially without issues such as the significant movement of electrical components.

In another embodiment, a frequency-modulated continuous wave (FMCW) lidar system includes a collimator array arranged to effectively launch light beams from a waveguide or fiber array of the system into substantially free space. Beams outputted by the waveguide or fiber array may be collimated and propagated at different angles. The FMCW lidar system also includes an overall splitter and circulator arrangement which is arranged to provide multiple channels via a waveguide or fiber array that provide multiple beams to a lens arrangement, e.g., a collimator lens arrangement.

### DETAILED DESCRIPTION

The use of autonomous vehicles is increasing. As a result, the need for reliable, high performance, and relatively low-cost sensors is also increasing. Sensor systems used on autonomous vehicles, such as, for example, fully autonomous vehicles and/or semi-autonomous vehicles, typically include lidar units.

Coherent lidar systems, such as Frequency-Modulated Continuous Wave (FMCW) lidar systems or coherent lidar systems, may be used in autonomous vehicles. Frequency-modulated continuous wave (FMCW) lidar is becoming more prevalent in autonomous vehicles. In general, while multiple FMCW lidar units may be included in a sensor system of an autonomous vehicle to provide multiple fields of view, the cost associated with FMCW lidar units often renders the use of multiple FMCW lidar units to be impractical.

As will be appreciated by those skilled in the art, a FMCW lidar system generally scans a continuous light or laser beam across a field of view, and may measure distances by linearly chirping a frequency of the continuous light beam. Often, to achieve beam steering, a FMCW lidar may use a two-dimensional Galvo mirror system. A FMCW lidar that includes a two-dimensional Galvo mirror system may have a relatively limited field of view. Typically, for example, a two-dimensional Galvo mirror system may have a substantially maximum of sixty-degree horizontal field of view and a substantially maximum of sixty-degree vertical field of view. In addition, a two-dimensional Galvo mirror system may be relatively bulky. Further, a FMCW lidar that includes a two-dimensional Galvo mirror system may be relatively expensive, as the number of Galvo mirrors needed to enable a 360-degree horizontal field of view may cost on the order of thousands of dollars.

In one embodiment, a FMCW lidar system may be provided with beam steering or scanning mechanisms which perform a substantially three-dimensional scanning of real space such that the FMCW lidar system may efficiently identify information including, but not limited to including, distances, intensities, and/or velocities. The ability to steer or scan a beam approximately 360 degrees horizontally and approximately twenty degrees vertically may provide relatively long-range detection using fewer lidar units or systems. An approximately twenty-degree vertical field of view may generally be sufficient for long-range detection, and an approximately 360-degree horizontal field of view allows the number of lidar systems needed for an autonomous vehicle to have an approximately 360-degree horizontal field of view. Such a field of view configuration is similar to the field of view provided using Time-of-Flight (TOF) lidar systems, but is simpler than a TOF scanning mechanism as an FMCW lidar beam steering mechanism generally does not utilize moving electrical components. The use of an FMCW lidar system which may perform a substantially three-dimensional scanning of real space may generally reduce the number of lidar units needed to ensure that an autonomous vehicle may operate safely.

By providing an overall FMCW lidar unit with an arrangement that enables the overall FMCW lidar unit to effectively provide multiple channels or beams associated with a substantially single source, e.g., light source, a substantially single FMCW lidar unit may provide multiple fields of view. In one embodiment, beams from different channels of a waveguide or fiber array of a FMCW lidar unit illuminate a lens at different positions such that each beam is effectively refracted to a different angle. The lens is also used to essentially collimate each beam. The lens may be single lens or a combination of several lenses. The output pattern, as generated when passing through the lens, may vary depending upon factors including, but not limited to including, the focal length of the lens and/or the waveguide or fiber array spatial distribution.

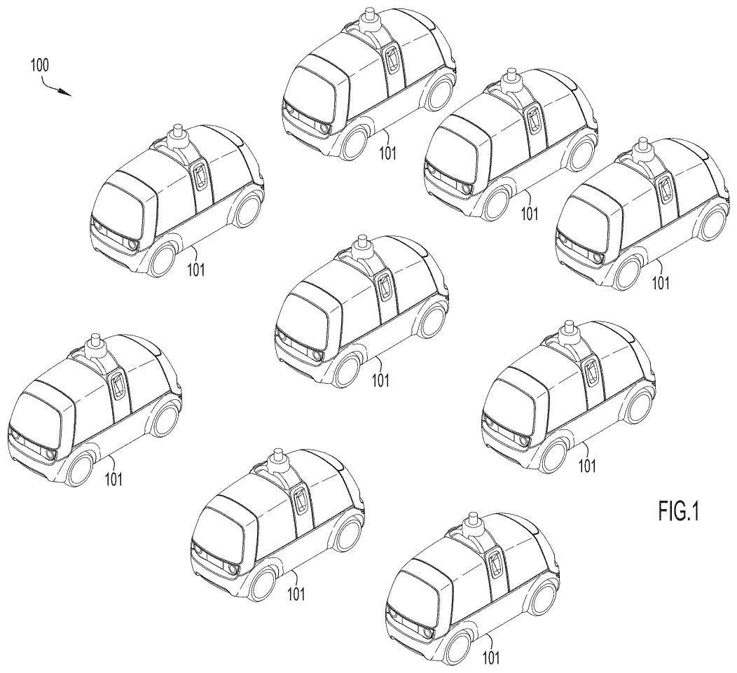

An autonomous vehicle such as an autonomous delivery vehicle that utilizes a FMCW lidar system with the ability to scan a beam up to approximately 360 degrees horizontally and up to twenty degrees, or more, vertically may be part of an autonomous vehicle fleet. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

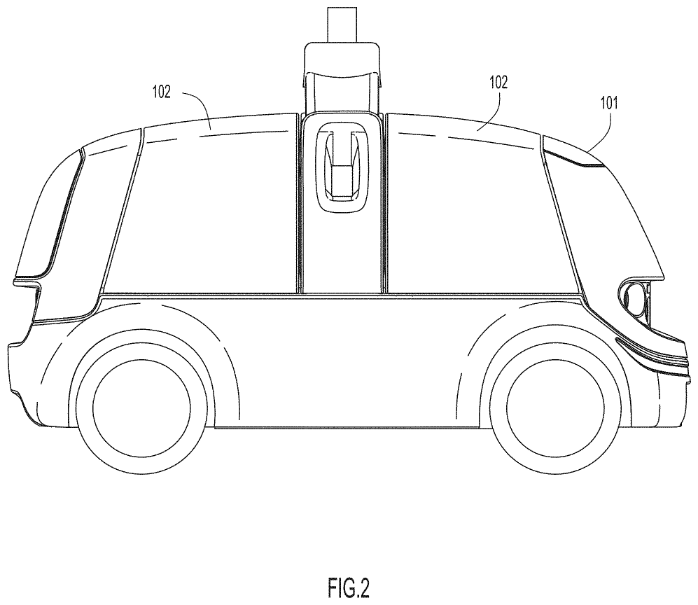

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

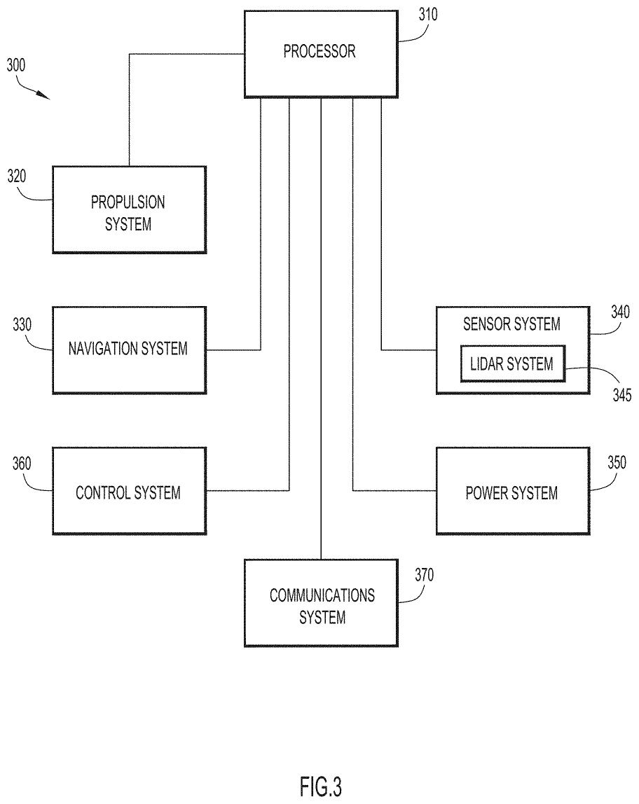

FIG. 3 is a block diagram representation of system components 300 an autonomous vehicle, e.g., autonomous vehicle 101 of FIG. 1, in accordance with an embodiment. The system components 300 include a processor 310, a propulsion system 320, a navigation system 330, a sensor system 340 that includes a lidar system 345, a power system 350, a control system 360, and a communications system 370. It should be appreciated that processor 310, propulsion system 320, navigation system 330, sensor system 340, power system 350, and control system 360 may be coupled/mounted to a chassis or body of autonomous vehicle 101.

Processor 310 is arranged to send instructions to and to receive instructions from or for various components such as propulsion system 320, navigation system 330, sensor system 340, power system 350, and control system 360. Propulsion system 320 is a conveyance system is arranged to cause autonomous vehicle 101 to move, e.g., drive. For example, when autonomous vehicle 101 is configured with a multi-wheeled automotive configuration as well as steering, braking systems and an engine, propulsion system 320 may be arranged to cause the engine, wheels, steering, and braking systems to cooperate to drive. In general, propulsion system 320 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 330 may control propulsion system 320 to navigate autonomous vehicle 101 through paths and/or within unstructured open or closed environments. Navigation system 330 may include at least one of digital maps, street view photographs, and a global positioning system (GPS) point. Maps, for example, may be utilized in cooperation with sensors included in sensor system 340 to allow navigation system 330 to cause autonomous vehicle 101 to navigate through an environment.

Sensor system 340 includes any sensors, as for example LiDAR, radar, ultrasonic sensors, microphones, altimeters, and/or cameras. Sensor system 340 generally includes onboard sensors that allow autonomous vehicle 101 to safely navigate, and to ascertain when there are objects near autonomous vehicle 101. In one embodiment, sensor system 340 may include propulsion systems sensors that monitor drive mechanism performance, drive train performance, and/or power system levels. In an embodiment as shown, sensor system 340 includes a lidar system 345 that enables beam scanning of approximately 360 degrees horizontally and approximately twenty degrees vertically. The lidar system 345 may be configured to use FMCW lidar techniques. Furthermore, the lidar system 345 may include a beam splitter and circulator arrangement. Lidar system 345 will be discussed in more detail below.

Power system 350 is arranged to provide power to autonomous vehicle 101. Power may be provided as electrical power, gas power, or any other suitable power, e.g., solar power or battery power. In one embodiment, power system 350 may include a main power source, and an auxiliary power source that may serve to power various components of autonomous vehicle 101 and/or to generally provide power to autonomous vehicle 101 when the main power source does not does not have the capacity to provide sufficient power.

Communications system 370 allows autonomous vehicle 101 to communicate, as for example, wirelessly, with a fleet management system (not shown) that allows autonomous vehicle 101 to be controlled remotely. Communications system 370 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 360 may cooperate with processor 310 to determine where autonomous vehicle 101 may safely travel, and to determine the presence of objects in a vicinity around autonomous vehicle 101 based on data, e.g., results, from sensor system 340. In other words, control system 360 may cooperate with processor 310 to effectively determine what autonomous vehicle 101 may do (e.g., how it can safely move about) within its immediate surroundings. Control system 360 in cooperation with processor 310 may essentially control power system 350 and navigation system 330 as part of driving or conveying autonomous vehicle 101. Additionally, control system 360 may cooperate with processor 310 and communications system 370 to provide data to or obtain data from other autonomous vehicles 101, a management server, a global positioning server (GPS), a personal computer, a teleoperations system, a smartphone, or any computing device via the communications system 370. In general, control system 360 may cooperate at least with processor 310, propulsion system 320, navigation system 330, sensor system 340, and power system 350 to allow vehicle 101 to operate autonomously. That is, autonomous vehicle 101 is able to operate autonomously through the use of an autonomy system that effectively includes, at least in part, functionality provided by propulsion system 320, navigation system 330, sensor system 340, power system 350, and control system 360.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 340 may be processed such that the environment around autonomous vehicle 101 may effectively be perceived.

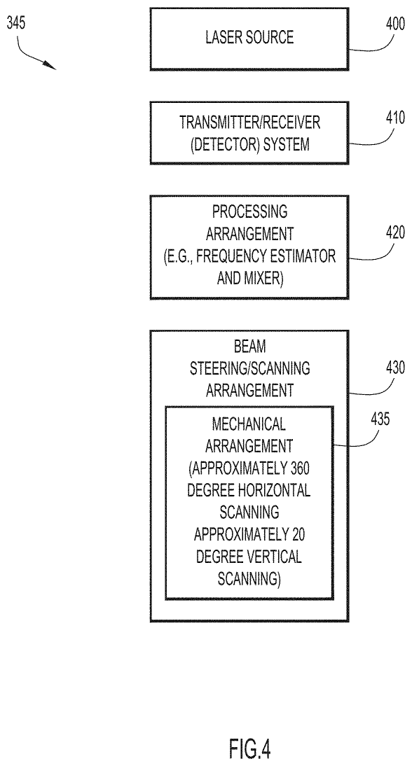

Referring next to FIG. 4, a lidar system which may scan a light or laser beam up to approximately 360 degrees horizontally and up to approximately twenty degrees (or more) vertically, e.g., lidar system 345 of FIG. 3, will be described in accordance with an embodiment. Lidar system 345 includes a light or laser source 400, a transmitter/receiver system 410, a processing arrangement 420, and a beam steering/scanning arrangement 430. Laser source 400 provides a laser beam that may be transmitted by transmitter/receiver system 410. Transmitter/receiver system 410 also receives or detects a reflected light. Processing arrangement 420 includes various components including, but not limited to including, a frequency estimator and a mixer. Beam steering/scanning arrangement 430 is configured to include components that allow a laser beam provided by laser source 400 to be scanned.

Lidar system 345 may be a coherent lidar system such as a FMCW lidar system. A FMCW lidar system may be configured to perform substantially three-dimensional scanning in real space. In one form of the lidar system 345, beam steering/scanning arrangement 430 includes a mechanical arrangement 435 that is configured to provide approximately 360 degrees of horizontal scanning and approximately 20 degrees of vertical scanning.

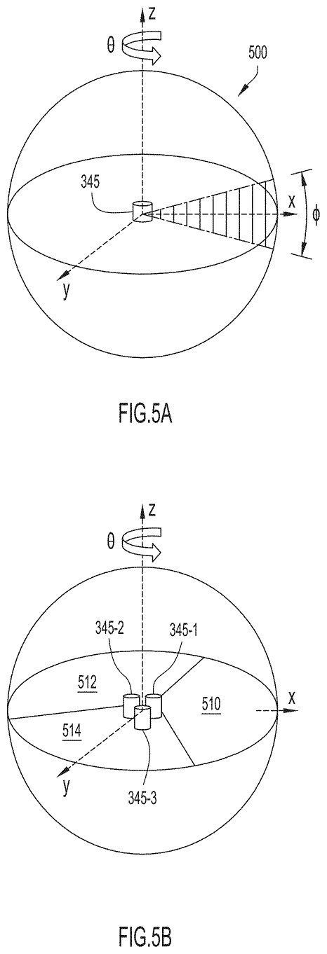

FIG. 5A is a diagrammatic representation of lidar system 345 shown with a horizontal scanning range of approximately 360 degrees and a vertical scanning range of approximately twenty degrees in accordance with an embodiment. Lidar system 345 is configured to scan one or more laser beams as rotation θ is provided about a z-axis. In the described embodiment, rotation θ corresponds to approximately 360 degrees, or a horizontal scanning range of approximately 360 degrees, shown at 500. Lidar system 345 is further configured to scan on or more laser beams at an angle ϕ, which corresponds to a vertical scanning range of approximately twenty degrees.

FIG. 5B shows a variation of FIG. 5A in which there are multiple instances of lidar system 345, each of which covers a portion of the full 360 degrees horizontal field of view. For example, a first lidar system 345-1 covers a first 120 degrees horizontal field of view 510, a second lidar system 345-2 covers a second 120 degrees horizontal field of view 512 and a third lidar system 345-3 covers a third 120 degrees horizontal field of view 514. While not shown in FIG. 5B for simplicity, it is to be understood the each of the first, second and third lidar systems 345-1-345-3 each also covers a vertical field of view similar to that shown in FIG. 5A.

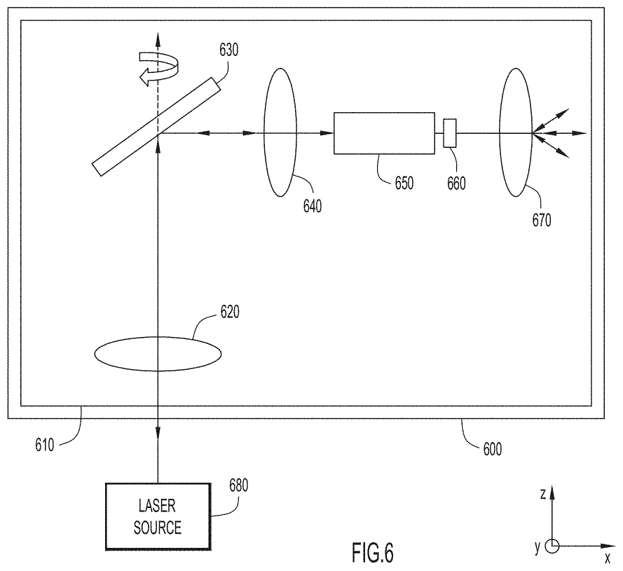

A mechanical arrangement of a beam steering/scanning arrangement of a lidar system such as lidar system 345 may vary widely while providing substantially three-dimensional scanning of real space. With reference to FIGS. 6-12, embodiments of suitable mechanical arrangements will be discussed.

FIG. 6 is a diagrammatic representation of a beam steering arrangement 600 of a FMCW lidar system that includes a mirror and a plane light-wave circuit (PLC) in accordance with an embodiment. A beam steering arrangement 600 includes a mechanical arrangement 610. Mechanical arrangement 610 includes a first collimator lens 620, a mirror 630, a second collimator lens 640, a PLC splitter 650, a fiber array 660, and a lens 670. PLC splitter 650 is generally arranged to substantially divide a light or laser beam into multiple beams, and/or to substantially combine multiple beams to effectively form a substantially single light beam.

A laser source 680 provides at least one laser beam through first collimator lens 620 to rotating mirror 630. The laser beam is then provided through second collimator lens 640 to PLC splitter 650. Lens 670 is generally arranged to emit a beam and to receive a beam.

PLC splitter 650 cooperates with fiber array 660, and utilizes optics provided by lens 670, to substantially create a vertical scanning field of view, e.g., a vertical scanning field of view of up to approximately twenty degrees, or more. When combined with mirror 630 that rotates about a vertical axis, second collimator lens 640, PLC splitter 650, fiber array 660, and lens 670 create a horizontal scanning field of view, e.g., a horizontal scanning field of view of up to approximately 360 degrees. Thus, the beam steering arrangement 600 can achieve a vertical scanning field of view of up to approximately twenty degrees or more, and a horizontal scanning field of view of up to approximately 360 degrees. Moreover, it should be understood that multiple instances of the beam steering arrangement 600 (and an associated laser source) may be employed to scan different portions of a 360 degrees horizontal field of view, as depicted in FIG. 5B.

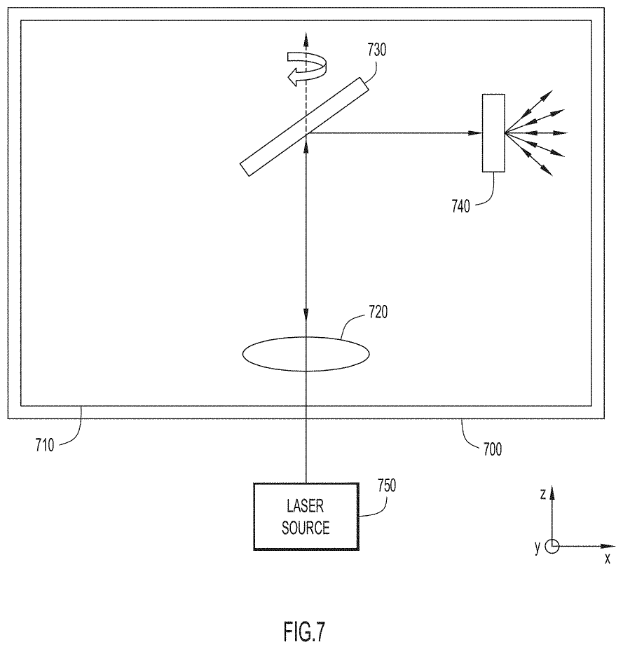

FIG. 7 is a diagrammatic representation of a beam steering arrangement 700 of a FMCW lidar system that includes a mirror and a diffractive optical element (DOE) in accordance with an embodiment. The beam steering arrangement 700 includes a mechanical arrangement 710. Mechanical arrangement 710 includes a lens 720, a mirror 730, and a DOE 740. A laser source 750 provides at least one laser beam through lens 720 to mirror 730, which rotates about a vertical axis to provide a horizontal scanning field of view. The laser beam is then provided to DOE 740 that effectively causes the laser beam to diverge to create a vertical scanning field of view. It should be appreciated that in some embodiments, in lieu of DOE 740, other optical components that may cause divergence of a beam, may be used. Other suitable optical components may include, but are not limited to including, lenses and/or prisms. It should be appreciated that DOE 740 is generally arranged to effectively emit beams and to receive beams.

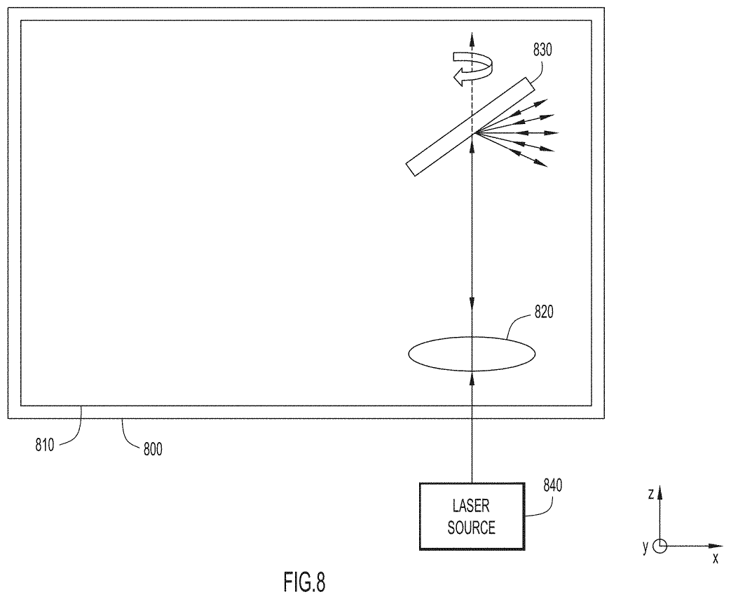

FIG. 8 is a diagrammatic representation of a beam steering arrangement 800 of a FMCW lidar system that includes a prism mirror in accordance with an embodiment. The beam steering arrangement 800 includes a mechanical arrangement 810. Mechanical arrangement 810 includes a lens 820, e.g., a collimator lens, and a prism mirror 830 that is arranged to rotate about a vertical axis to provide a horizontal scanning field of view. Prism mirror 830 may be composed of multiple mirror facets with tilt angles. The tilt angles may be varied, and mirror facets may have different tilt angles.

One or more beams provided by a laser source 840 may be provided to prism mirror 830 through lens 820. The mirror facets of prism mirror 830 may reflect a collimated beam in different directions to create a vertical canning field of view. Both emitted and received beams may be reflected off prism mirror 830, as indicated in FIG. 8.

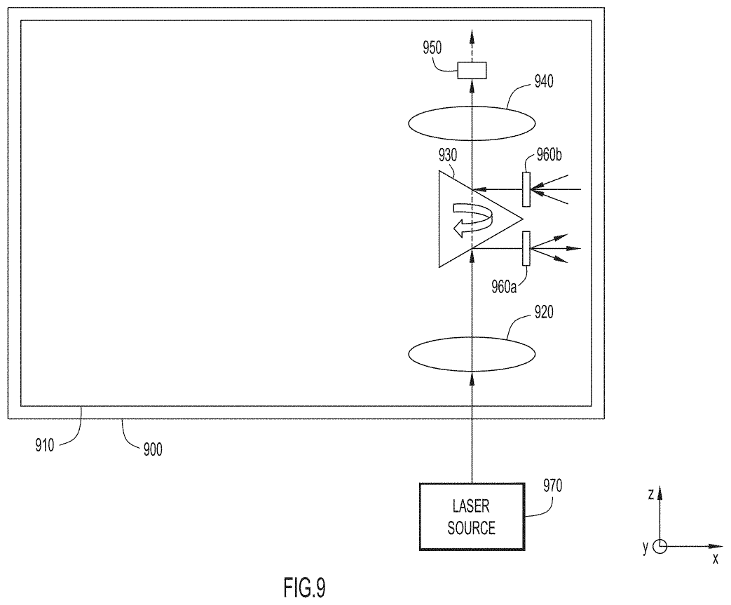

FIG. 9 is a diagrammatic representation of a beam steering arrangement 900 of a FMCW lidar system that includes a right-angle mirror or prism in accordance with an embodiment. The beam steering arrangement 900 includes a mechanical arrangement 910. Mechanical arrangement 910 includes a first collimator lens 920, a right-angle mirror or prism 930, a second collimator lens 940, a fiber tip 950, and a first diverse component 960a and a second diverse component 960b. Fiber tip 950 is generally an optical component that may be used to substantially reconfigure a light beam of a laser beam. As will be appreciated by those skilled in the art, diverse components 960a, 960b may generally include, but are not limited to including, optical lenses, DOEs, prisms, and/or substantially any component that may diverge a beam to create a substantially vertical scanning field of view.

A laser source 970 provides one or more beams through first collimator lens 920 to right angle mirror or prism 930. Right angle mirror or prism 930 is arranged to rotate about a vertical axis, along with diverse components 960a, 960b. The rotation about the vertical axis provides horizontal scanning. In the embodiment as shown, an emitting light or beam path may be associated with diverse component 960a, while a receiving light or beam path may be associated with diverse component 960b. Further, emitted beams and received beams may reflect at different sides of right-angle mirror or prism 930. Received beams may reflect off right-angle mirror or prism 930. As a beam emitting system is substantially separate from receiving system, or a system for receiving reflected beams, the amount of noise return from fiber tip 950 may be reduced.

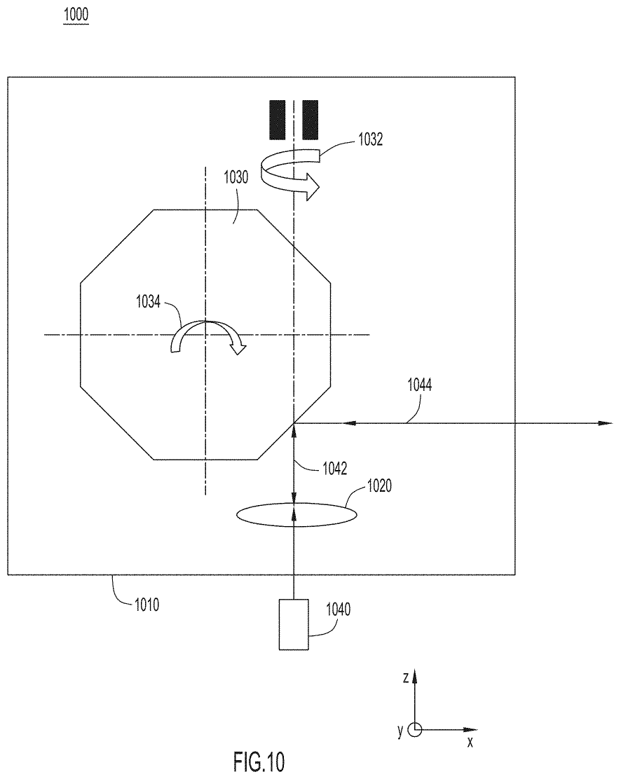

FIG. 10 is a diagrammatic representation of a beam steering arrangement 1000 of a FMCW lidar system that includes a polygonal or polygon mirror in accordance with an embodiment. The beam steering arrangement 1000 includes a mechanical arrangement 1010. Mechanical arrangement 1010 includes a lens 1020 and a polygon mirror 1030. A laser source 1040 provides a beam that passes through lens 1020 to polygon mirror 1030. Polygon mirror 1030 rotates about both an off-center axis as shown at 1032 and about a vertical axis as shown at 1034. Rotation about the off-center axis achieves the vertical scanning field of view, and rotation about the vertical axis 1034 achieves the horizontal scanning field of view, when a beam reflects or is otherwise deflected off a face of polygon mirror 1030. Both beams emitted by laser source 1040 and beams received by beam steering arrangement 1000 may reflect off polygon mirror 1030, as shown at 1042 and 1044.

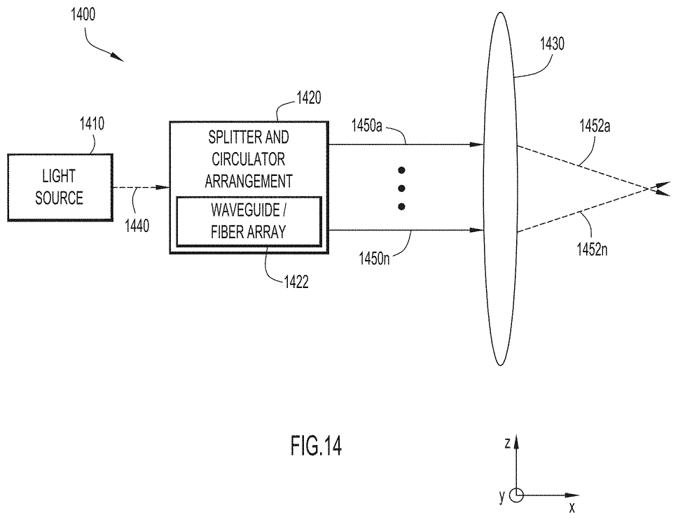

In one form, the beam steering arrangement 1000 of FIG. 10 may be configured to use beam splitting techniques, described below in connection with FIGS. 14-17, instead of rotation about the central axis 1032, to achieve a vertical scanning field of view. Thus, the beam steering arrangement 1000 may achieve a horizontal scanning field of view by rotation about the vertical axis 1034 and achieve a vertical scanning field of view using beam steering techniques.

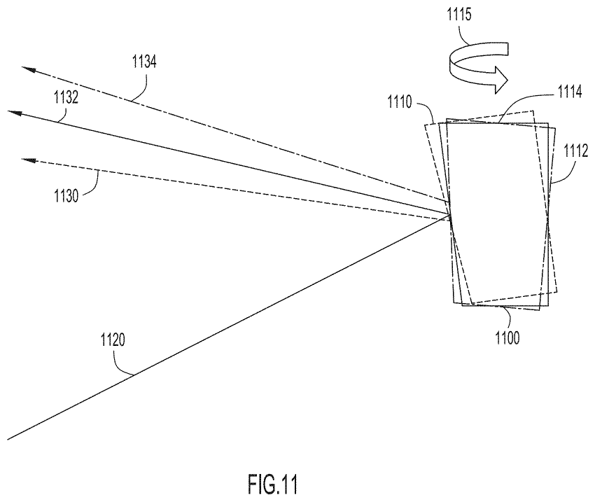

Reference is now made to FIG. 11. FIG. 11 shows a polygon mirror 1100 that may be used in the beam steering arrangement 1000 of FIG. 10 to achieve a 120 degrees horizontal scanning field of view. The polygon mirror 1100 has several faces 1110, 1112 and 1114 each with different surface angles to achieve a relatively sparse vertical scanning field of view, e.g., 8-10 degrees. The faces 1110, 1112 and 1114 of the polygon mirror 1100 may be tilted from vertical by several degrees to achieve scanning of multiple lines, as shown in FIG. 11. When the polygon mirror 1100 is rotated as shown at 1115, a laser 1120 is reflected by the different faces and then propagates at different vertical angles, as shown at 1130, 1132 and 1134.

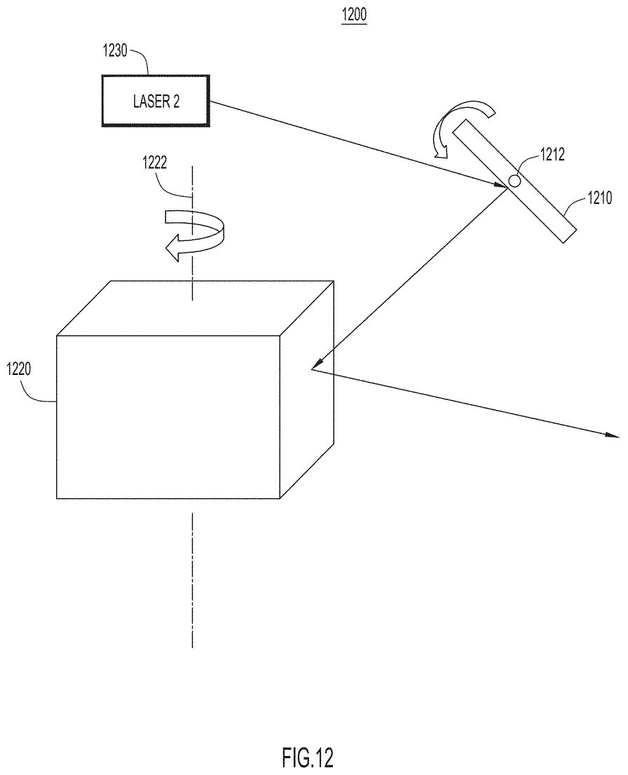

FIG. 12 shows a beam steering arrangement according to another example embodiment. The beam steering arrangement 1200 includes a galvanometer (Galvo) 1210 mirror and a polygon mirror 1220. The Galvo mirror 1210 can rotate or swing about its center horizontal axis 1212, while the polygon mirror 1220 can rotate about its center vertical axis 1222. A laser 1230 emits a beam that hits the Galvo mirror 1210. The Galvo mirror 1210 rotates or swings about its center horizontal axis 1212, providing a vertical scanning field of view function. Reflected light hits the mirror surfaces of the polygon mirror 1220. The polygon mirror 1220 rotates around its center vertical axis 1222, providing a horizontal scanning field of view. The emitting beam can be either a single beam or multiple beams. The receiving beam can share with the same path as the emitting beam.

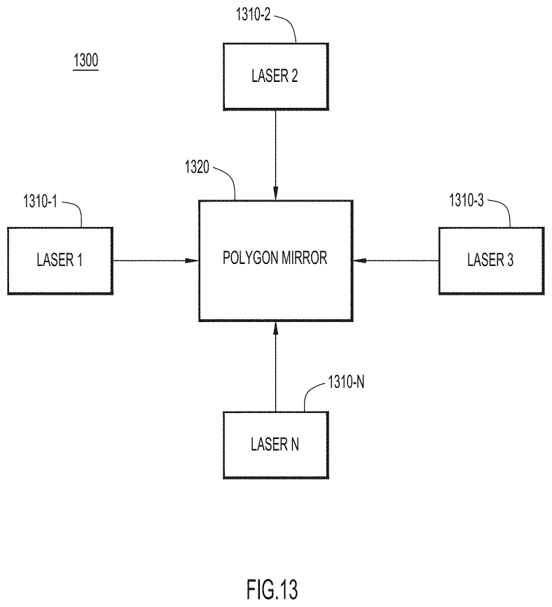

FIG. 13 illustrates an example of a beam steering arrangement for a lidar system that can achieve a 360-degree horizontal field of view. The beam steering arrangement 1300 may include a plurality of lasers 1310-1, 1310-2, 1310-3, . . . , 1310-N and a polygon mirror 1320 having multiple faces with different face angles, as depicted in FIG. 11. Each laser 1310-1 through 1310-N is scanned at each face of the polygon mirror 1320. It is also envisioned that one laser may be used with one or more splitters to generate N beams instead of N lasers. Different circulators and analog-to-digital converts may be used to collect signals for different outputs.

FIGS. 14-17 illustrate examples of arrangements for beam splitting that may be used to achieve a vertical scanning field of view for a lidar system. These beam splitting arrangements may be used alone or in connection with the beam steering arrangements depicted in FIGS. 4-13.

With reference to FIG. 14, a lidar system 1400 will be described in accordance with an embodiment. Lidar system 1400 includes a light source 1410, a splitter and circulator arrangement 1420, and a lens arrangement 1430. Splitter and circulator arrangement 1420 may include a waveguide and/or fiber array 1422.

Light source 1410 is configured to emit a light beam 1440 that is substantially processed by splitter and circulator arrangement 1420. Splitter and circulator arrangement 1420, which may generally include a waveguide and/or fiber array 1422, is configured to effectively generate multiple output channels or beams 1450a-n from beam 1440. Output beams 1450a-n are provided to lens arrangement 1430 that collimates output beams 1450a-n and propagates beams 1452a-n at different angles. That is lens arrangement 1430 receives beams 1450a-n from waveguide and/or fiber array 1422, as for example on multiple fibers, and launches propagated beams 1452a-n substantially into free space. As such, lidar system 1400 is effectively configured to substantially transform a single beam 1440 into propagated beams 1452a-n.

The number of beams 1450a-n and, hence, the number of beams 1452a-n, may vary based on factors including, but not limited to including, the requirements of a system in which lidar system 1400 is to be used, an acceptable cost of lidar system 1400, etc. That is, “n” may vary widely. In one embodiment, “n” may be between approximately two and approximately thirty two (32). By way of example, “n” may be approximately eight.

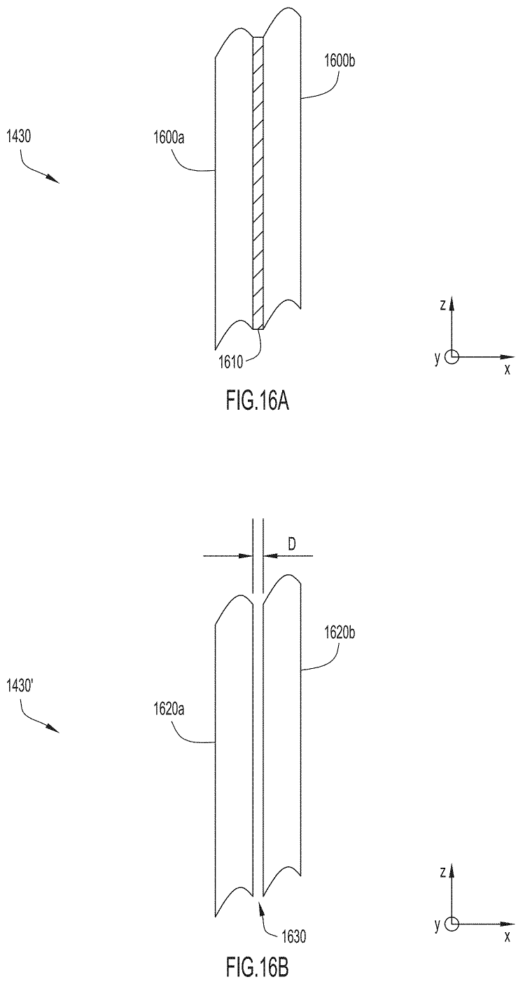

Lens arrangement 1430 may generally include one or more lenses. In other words, lens arrangement 1430 may be formed as a single lens or a combination of multiple lenses. It should be appreciated that when lens arrangement 1430 is formed from multiple lenses, e.g., is configured as an array of lenses, the multiple lenses may be aligned such that each output beam 1452a-n passes through all of the multiple lenses. The configuration of two or more lenses in lens arrangement 1430 will be discussed below with respect to FIGS. 16A and 16B.

Splitter and circulator arrangement 1420 is generally arranged to effectively split beam 1440, as for example based on a designated beam splitting ratio, and to substantially transmit beams 1450a-n, after splitting via waveguide and/or fiber array 1422, to lens arrangement 1430.

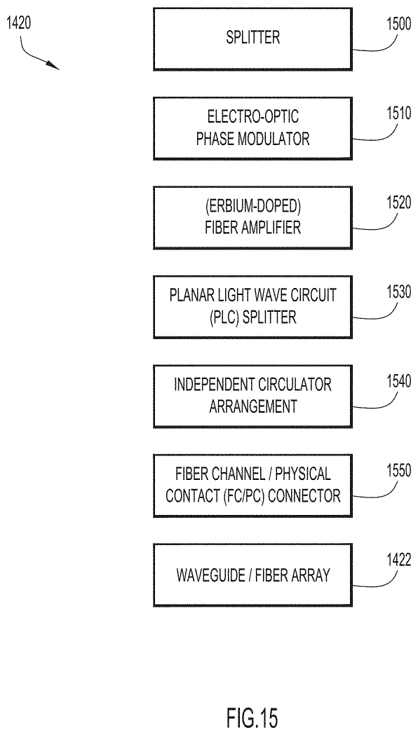

FIG. 15 is a block diagram representation of splitter and circulator arrangement 1420, in accordance with an embodiment. Splitter and circulator arrangement 1420 may include, in one embodiment, in addition to the waveguide and/or fiber array 1422, a splitter 1500, an electro-optic phase modulator 1510, a fiber amplifier 1520, a planar light wave circuit (PLC) splitter 1530, an independent circulator arrangement 1540, a fiber channel/physical contact (FC/PC) connector 1550.

Splitter 1500 is configured to obtain a beam, e.g., a light beam, from a source such as a light source or a laser source, and to split the beam. Splitter 1500 may provide at least a portion of the split beam to phase modulator 1510 that may process or otherwise manipulate the phase associated with the split beam, and provide a phase modulated split beam to fiber amplifier 1520, which may be an erbium-doped fiber amplifier. Fiber amplifier 1520 may amplify the phase modulated split beam, and provide the amplified phase modulated split beam to PLC splitter 1530.

PLC splitter 1530 may effectively split the amplified phase modulated split beam. For example, PLC splitter 1530 may substantially evenly divide the amplified phase modulated split beam into multiple beams or signals. In one embodiment, PLC splitter 1530 may divide the amplified phase modulated split beam into eight output beams. Each of the beams, e.g., each of the eight beams, is provided to independent circulator arrangement 1540. In general, independent circulator arrangement 1540 may include one independent circulator for each output beam. Independent circulator arrangement 1540, which may include multiple optical circulators, effectively routes output beams to FC/PC connector 1550 that cooperates with waveguide/fiber array 1422 to provide the output beams to a lens arrangement.

As previously mentioned, a lens arrangement of a lidar system may be formed from more than one lens. For example, two or more lenses may be substantially bonded together such that there is effectively no air gap between adjacent lenses. Alternatively, two or more lenses may be positioned with air gaps between adjacent lenses.

FIG. 16A is a diagrammatic side-view representation of a lens arrangement of a lidar system, e.g., lens arrangement 1430 of FIG. 14, with lenses which are bonded together in accordance with an embodiment. Lens arrangement 1430 includes at least two lenses 1600a, 1600b. Lenses 1600a, 1600b cooperate to collimate different beams or channels of a waveguide and/or fiber array. Lenses 1600a, 1600b may be substantially bonded together using an adhesive 1610 such that there is effectively no air gap between lens 1600a and lens 1600b. Adhesive 1610 may form a relatively thin layer between lens 1600a and lens 1600b, and may be any suitable bonding agent, e.g., glue.

FIG. 16B is a diagrammatic side-view representation of lens arrangement 1430 of FIG. 4 in which lenses have not been bonded together in accordance with an embodiment. Lens arrangement 1430′ includes a first lens 1620a and a second lens 1620b which are substantially separated by a distance D. The separation between first lens 1620a and second lens 1620b is effectively an air gap 1630 that has a width of distance D. Distance D may vary widely depending upon factors including, but not limited to including, desired angles of refraction for beams passing through lenses 1620a, 1620b.

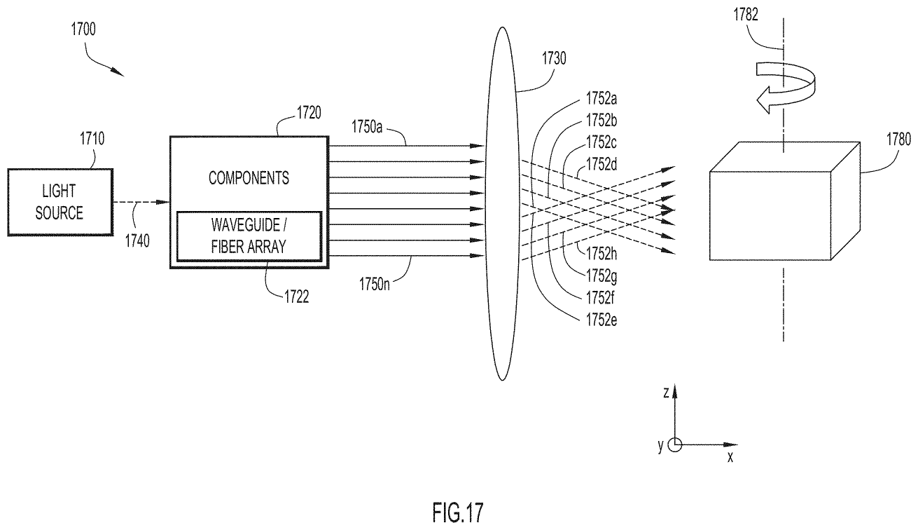

FIG. 17 is a diagrammatic representation of a lidar system 1700 with a fiber array collimator that shows beams passing through different locations of a lens arrangement in accordance with an embodiment. The lidar system 1700 includes the arrangement similar that of the lidar system 1400 shown in FIG. 14, but the lidar system 1700 also includes a rotating polygon mirror that is used to generate the horizontal scanning field of view.

The lidar system 1700 includes a light source 1710 that includes components 1720 that may generally include a waveguide and/or fiber array 1722, and a lens arrangement 1730. In one embodiment, components 1720 may be a splitter and circulator arrangement, such as splitter and circulator arrangement 1420 shown in FIG. 15. Light source 1710 generates a light beam 1740 that is coupled to the components 1720.

Components 1720 effectively form or otherwise produce, from light beam 1740, output beams 1750a-1750h or signals. In the described embodiment, the components split single beam 1740 into approximately eight beams or signals 1750a-1750h which may be provided to the lens arrangement 1730. That is, beams 1750a-1750h form different channels, via waveguide and/or fiber array 1722, and illuminate lens arrangement 1730 at different positions along lens arrangement 1730, e.g., relative to a z-axis,

Lens arrangement 1730 may collimate beams 1750a-1750h, and cause beams 1750a-1750h to be refracted to different angles to effectively form refracted beams 1752a-1752h which create an output pattern. The output pattern created by refracted beams 1752a-1752h may depend upon factors including, but not limited to including, the focal length of lens arrangement 1730 and a spatial distribution of waveguide and/or fiber array 1722. FIG. 17 thus shows the vertical distance separation between the beams 1750a-1750h to angle separation between refracted beams 1752a-1752h. The beams 1752a-1752h may span a scanning range in a vertical directional field of view.

FIG. 17 further shows a polygon mirror 1780 that is configured to rotate about a vertical axis 1782. The beams 1752a-1752h strike the polygon mirror 1780 as the polygon mirror 1780 rotates to scan the beams 1752a-1752h in a horizontal field of view. Thus, the lidar system 1700 achieves scanning in a vertical field of view and scanning in a horizontal field of view, similar to that shown in FIG. 5A.

While FIG. 17 shows the generation of 8 beams, there may be use cases where more beams are needed, such as 32 or 64 beams. This may be achieved by deploying multiple horizontally offset instances of the components depicted in FIG. 17, or by employing a polygon mirror having different faces with different angles, as described above in connection with FIG. 11.

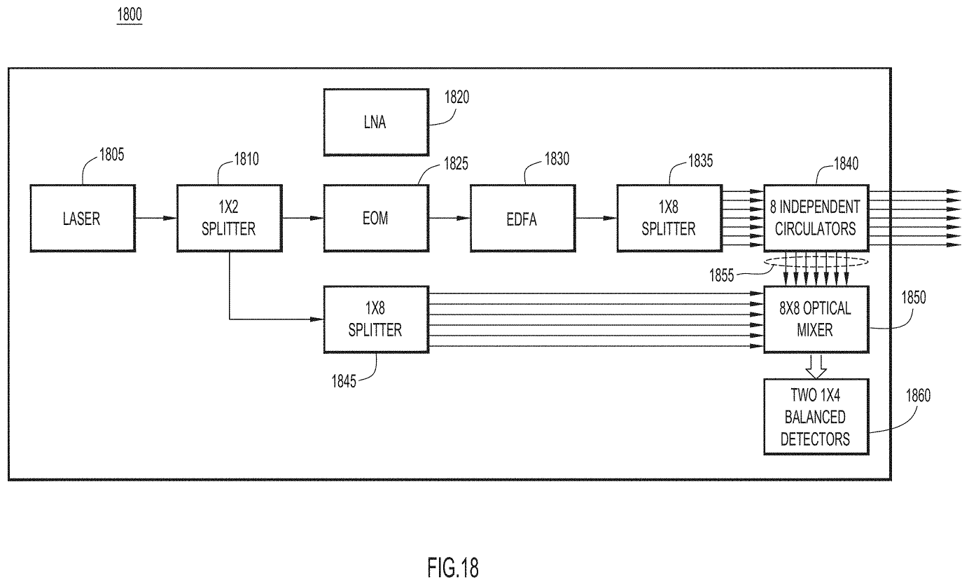

FIG. 18 is a block diagram of a lidar system 1800 according to an embodiment. The lidar system 1800 includes, in a transmit path, a laser 1805, a 1×2 splitter 1810, a low noise amplifier (LNA) 1820, an electro-optical modulator (EOM) 1825, an EDFA 1830, a 1×8 splitter 1835, and a bank of independent circulators 1840. The laser 1805 provides a light beam to the splitter 1810 which generates two output light beams, one of which is directed to the EOM 1825. The splitter 1835 splits a light beam into eight (8) light beams, but that is only an example. The splitter 1835 could split out into any number of light beams.

The EOM 1825 modulates the light beam according to a desired modulation scheme, e.g., FMCW modulation, and the modulated light beam is coupled to the EDFA 1830. The EDFA 1830 amplifies the modulated light beam to output an amplified modulated light beam. The splitter 1835 splits the amplified modulated light beam into eight light beams that are supplied to the bank of circulators 1840. The bank of independent circulators 1840 routes the split out light beams from the splitter 1835 to downstream optical components, such as a FC/PC connector arrangement, a waveguide/fiber array, a lens arrangement and a rotating mirror (not shown in FIG. 18, but shown in FIGS. 14, 15 and 17).

The lidar system 1800 further includes a 1×8 splitter 1845 and an 8×8 optical mixer 1850. The optical mixer 1850 mixes reflected light 1855 (from one or more targets, not shown) obtained by the bank of independent circulators 1840. The optical mixer 1850 is coupled to two 1×4 balanced detectors 1860. The two balanced detectors 1860 convert the eight (8) detected light beams to electrical signals for analysis.

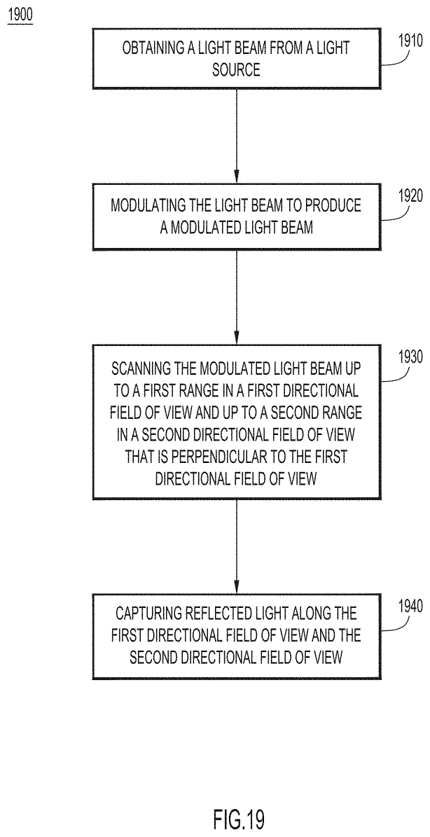

Reference is now made to FIG. 19. FIG. 19 illustrates a flow chart of a method 1900, according to an example embodiment. The method 1900 is a method for scanning a light beam in a lidar system. The method 1900 includes a step 1910 for obtaining a light beam from a light source. At step 1920, the method 1900 includes modulating the light beam to produce a modulated light beam. At step 1930, the method includes scanning the modulated light beam up to a first range in a first directional field of view and up to a second range in a second directional field of view that is perpendicular to the first directional field of view. In one embodiment, the first directional field of view is a horizontal directional field of view and the first range is 360 degrees, and the second directional field of view is a vertical directional field of view and the second range is approximately 20 degrees. At step 1940, the method 1900 includes capturing reflected light along the first directional field of view and the second directional field of view.

In one form, the first directional field of view is a horizontal directional field of view and the first range is 360 degrees, and the second directional field of view is a vertical directional field of view and the second range is approximately 20 degrees.

In one form, the scanning step 1930 of the method 1900 may include: splitting the light beam from the light source with a beam splitter to produce a plurality of light beams; directing the plurality of light beams with a lens arrangement to span the second range in the second directional field of view; rotating the beam splitter and the lens arrangement about an axis substantially perpendicular to the first directional field of view up to the first range to scan the plurality of light beams in the first directional field of view.

In another form, the scanning step 1930 of the method 1900 may include: splitting the light beam; phase modulating a portion of the light beam split by the splitting to provide a phase modulated split beam; amplifying the phase modulated split beam and to provide an amplified phase modulated split beam; dividing the amplified phase modulated split beam into multiple beams; and routing the multiple beams to individual waveguides or fibers of a waveguide and/or fiber array.

In still another form, the scanning step 1930 of the method 1900 may include: rotating a galvanometer mirror about a center horizontal axis to scan the light beam in the vertical directional field of view; receiving at a polygon mirror a reflected light beam from the galvanometer mirror; and rotating the polygon mirror about a center vertical axis to scan the light beam in the horizontal directional field of view.

Although only a few embodiments have been described in this disclosure, it should be understood that the disclosure may be embodied in many other specific forms without departing from the spirit or the scope of the present disclosure. By way of example, a lens arrangement of an FMCW lidar unit has been described as being formed either as a single lens or as an array of lenses that are aligned such that beams substantially pass through each lens of the array of lenses. That is, a lens arrangement that is an array of lenses has been described as including two or more lenses that are each associated with the multiple fibers. In one embodiment, a lens arrangement may include an array of lenses that are aligned such that each beam passes through a dedicated lens associated with that beam. In other words, a lens arrangement may include a series of lenses configured such that each lens is substantially associated with a single fiber. Moreover, by way of example, while a beam steering or scanning arrangement of a coherent lidar system such as an FMCW lidar system have been described as providing horizontal scanning of approximately 360 degrees and vertical scanning of approximately twenty degrees, it should be appreciated that the horizontal scanning and vertical scanning may vary. Using the mechanical arrangement of beam scanning arrangements described above, horizontal scanning of less than approximately 360 degrees and/or vertical scanning of more than or less than twenty degrees may be provided in some embodiments.

In the embodiments described herein, the received/reflected light obtained as a result of scanning the outbound/transmitted light beams follow the same path and various techniques, known in the art, may be used to split out the receive light beams for conversion to electrical signals for analysis.

While examples of suitable beam steering/scanning arrangements that may provide three-dimensional real scanning have been described, it should be appreciated that other beam steering/scanning arrangements may be utilized. In general, any suitable beam steering/scanning arrangement that may provide a coherent lidar system such as an FMCW lidar system which approximately up to 360 degrees of horizontal scanning and approximately up to 20 degrees of vertical scanning may be implemented.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code that may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

In summary, in one form, a lidar apparatus is provided comprising: at least one light source configured to provide a light beam; and a beam steering arrangement configured to scan the light beam up to a first range in a first directional field of view and to scan the light beam up to a second range in a second directional field of view that is perpendicular to the first directional field of view.

The first directional field of view may be a horizontal directional field of view and the first range is 360 degrees, and the second directional field of view may be a vertical directional field of view and the second range is approximately 20 degrees.

In one form, the beam steering arrangement includes: a reflective optical element arranged to reflect the light beam from the at least one light source; a beam splitter configured to split a reflected light beam from the reflective optical element to produce a plurality of light beams; and a lens arrangement to receive the plurality of light beams and direct the plurality of light beams spanning the second range in the second directional field of view; wherein the reflective optical element, the beam splitter and the lens arrangement are mounted to be rotated about an axis substantially perpendicular to the first directional field of view up to the first range to scan the plurality of light beams in the first directional field of view.

Moreover, the beam steering arrangement may include: a reflective optical element having first reflective face and a second reflective face at a right-angle to each other, the first reflective face configured to reflect the light beam from the at least one light source and the second reflective face configured to reflect incoming light; a first diverse optical element arranged to receive light reflected by the first reflective face to diverge light to create the second directional field of view; a second diverse optical element configured to receive incoming light reflected by one or more targets and to direct the incoming light to the second reflective face of the reflective optical element; wherein the reflective optical element, the first diverse optical element and the second diverse optical element are mounted to be rotated about an axis substantially perpendicular to the first directional field of view up to the first range to scan the plurality of light beams in the first directional field of view.

The reflective optical element may be a right-angle mirror or a prism, and the first diverse optical element and second diverse optical element are an optical lens, diffractive optical element or prism.

In another form, the beam steering arrangement includes: a polygon mirror having a plurality of faces and configured to receive a light beam from the at least one light source, the polygon mirror arranged to be rotated about a central axis of the polygon mirror to scan the light beam in the vertical directional field of view, and to be rotated about a vertical axis to scan the light beam in the horizontal directional field of view.

In yet another form, the beam steering arrangement includes: a polygon mirror having a plurality of faces, the polygon mirror arranged to be rotated about a vertical axis to scan light beams in the horizontal directional field of view; a splitter and circulator arrangement configured to receive the light beam from the at least one light source to split the light beam according to a beam splitting ratio to generate multiple output beams; and a lens arrangement configured to receive the multiple output beams to launch multiple propagated light beams at different angles so that the multiple propagated light beams span the second range of the vertical directional field of view, towards the polygon mirror. The polygon mirror may be an irregular polygon mirror, and wherein the plurality of faces of the polygon mirror is are tilted by a predetermined amount. The splitter and circulator arrangement may include a waveguide and/or fiber array configured to generate the multiple output beams from the light beam. The splitter and circulator arrangement may include: a splitter configured to receive the light beam from the at least one light source and split the light beam; a phase modulator configured to receive at least a portion of the light beam split by the splitter, the phase modulator configured to phase modulate the portion of the light beam split by the splitter to output a phase modulated split beam; a fiber amplifier configured to receive and amplify the phase modulated split beam and to output an amplified phase modulated split beam; a plane light-wave circuit splitter configured to divide the amplified phase modulated split beam into multiple beams; and an independent circulator arrangement configured to route the multiple beams to a fiber channel/physical contact connector that couples the multiple beams to individual waveguides or fibers of the waveguide and/or fiber array. The lens arrangement may comprise a single lens or a combination of multiple lenses configured to collimate different light beams output by the waveguide and/or fiber array, the multiple lenses aligned such that each of the multiple output beams passes through all of the multiple lenses. The multiple lenses may include at least a first lens and a second lens, wherein the first lens and the second lens are bonded together such that there is no air gap between them, or the first lens and the second lens are separated by an air gap.

In yet another form, the beam steering arrangement includes: a galvanometer mirror configured receive the light beam from the at least one light source and to be rotated about a center horizontal axis to scan the light beam in the vertical directional field of view; and a polygon mirror configured to receive a reflected light beam from the galvanometer mirror and configured to be rotated about a center vertical axis to scan the light beam in the horizontal directional field of view.

In still another form, the lidar apparatus comprises a plurality of beam steering arrangements each configured to scan in overlapping or non-overlapping portions of 360 degrees in the horizontal directional field of view.

In another form, a lidar apparatus is provided comprising: at least one light source configured to provide a light beam; a splitter and circulator arrangement configured to receive the light beam from the at least one light source to split the light beam according to a beam splitting ratio to generate multiple output beams; and a lens arrangement configured to receive the multiple output beams to launch multiple propagated light beams at different angles so that the multiple propagated light beams span a range of a vertical directional field of view.

The splitter and circulator arrangement may include a waveguide and/or fiber array configured to generate the multiple output beams from the light beam.

In one form, the splitter and circulator arrangement may further include: a splitter configured to receive the light beam from the at least one light source and split the light beam into multiple light beams; a phase modulator configured to receive one light beam of the multiple light beams split by the splitter, the phase modulator configured to phase modulate h the one light beam split by the splitter to output a phase modulated split beam; a fiber amplifier configured to receive and amplify the phase modulated split beam and to output an amplified phase modulated split beam; a plane light-wave circuit splitter configured to divide the amplified phase modulated split beam into multiple beams; and an independent circulator arrangement configured to route the multiple beams to a fiber channel/physical contact connector that couples the multiple beams to individual waveguides or fibers of the waveguide and/or fiber array.

In another form, the splitter and circulator arrangement includes: a first splitter configured to split the light beam into a first light beam and a second light beam; an electro-optical modulator configured to receive the first light beam and modulate the first light beam to produce a modulated light beam; an optical amplifier configured to amplify the modulated light beam to produce an amplified modulated light beam; a second splitter configured to split the amplified modulated light beam into a plurality of amplified modulated light beams; a bank of independent circulators configured to route the plurality of amplified modulated light beams to waveguides or fibers of a waveguide and/or fiber array, which in turn direct the plurality of amplified modulated light beams to the lens arrangement.

The lens arrangement may comprise a single lens or a combination of multiple lenses configured to collimate different light beams output by the waveguide and/or fiber array, the multiple lenses aligned such that each of the multiple output beams passes through all of the multiple lenses.

The lidar apparatus may further include a polygon mirror having a plurality of faces, the polygon mirror arranged to be rotated about a vertical axis and to receive the multiple propagated beams output by the lens arrangement to scan the multiple propagated light beams in a horizontal directional field of view.

In another form, a method for scanning a light beam in a lidar system, the method is provided that comprises: obtaining a light beam from a light source; modulating the light beam to produce a modulated light beam; scanning the modulated light beam up to a first range in a first directional field of view and up to a second range in a second directional field of view that is perpendicular to the first directional field of view; and capturing reflected light along the first directional field of view and the second directional field of view.

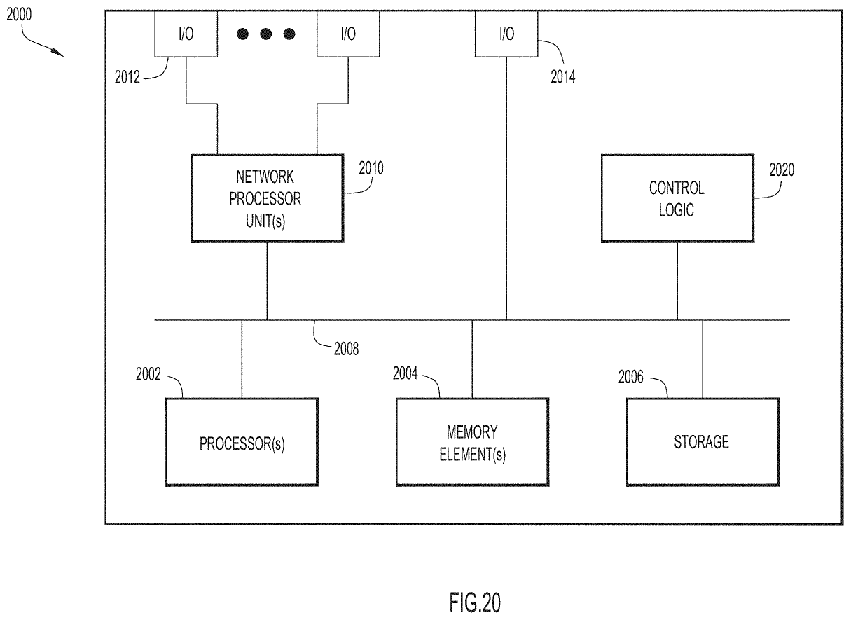

Referring to FIG. 20, FIG. 20 illustrates a hardware block diagram of a computing device 2000 that may perform functions associated with operations discussed herein in connection with the techniques depicted in FIGS. 1-19. In various embodiments, a computing device or apparatus, such as computing device 2000 or any combination of computing devices 2000, may be configured as any entity/entities as discussed for the techniques depicted in connection with FIGS. 1-19 in order to perform computing and/or signal processing operations of the various techniques discussed herein.

In at least one embodiment, the computing device 2000 may be any apparatus that may include one or more processor(s) 2002, one or more memory element(s) 2004, storage 2006, a bus 2008, one or more network processor unit(s) 2010 interconnected with one or more network input/output (I/O) interface(s) 2012, one or more I/O interface(s) 2014, and control logic 2020. In various embodiments, instructions associated with logic for computing device 2000 can overlap in any manner and are not limited to the specific allocation of instructions and/or operations described herein.

In at least one embodiment, processor(s) 2002 is/are at least one hardware processor configured to execute various tasks, operations and/or functions for computing device 2000 as described herein according to software and/or instructions configured for computing device 2000. Processor(s) 2002 (e.g., a hardware processor) can execute any type of instructions associated with data to achieve the operations detailed herein. In one example, processor(s) 2002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 2004 and/or storage 2006 is/are configured to store data, information, software, and/or instructions associated with computing device 2000, and/or logic configured for memory element(s) 2004 and/or storage 2006. For example, any logic described herein (e.g., control logic 2020) can, in various embodiments, be stored for computing device 2000 using any combination of memory element(s) 2004 and/or storage 2006. Note that in some embodiments, storage 2006 can be consolidated with memory element(s) 2004 (or vice versa), or can overlap/exist in any other suitable manner.

In at least one embodiment, bus 2008 can be configured as an interface that enables one or more elements of computing device 2000 to communicate in order to exchange information and/or data. Bus 2008 can be implemented with any architecture designed for passing control, data and/or information between processors, memory elements/storage, peripheral devices, and/or any other hardware and/or software components that may be configured for computing device 2000. In at least one embodiment, bus 2008 may be implemented as a fast kernel-hosted interconnect, potentially using shared memory between processes (e.g., logic), which can enable efficient communication paths between the processes.

In various embodiments, network processor unit(s) 2010 may enable communication between computing device 2000 and other systems, entities, etc., via network I/O interface(s) 2012 (wired and/or wireless) to facilitate operations discussed for various embodiments described herein. In various embodiments, network processor unit(s) 2010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 2000 and other systems, entities, etc. to facilitate operations for various embodiments described herein. In various embodiments, network I/O interface(s) 2012 can be configured as one or more Ethernet port(s), Fibre Channel ports, any other I/O port(s), and/or antenna(s)/antenna array(s) now known or hereafter developed. Thus, the network processor unit(s) 2010 and/or network I/O interface(s) 2012 may include suitable interfaces for receiving, transmitting, and/or otherwise communicating data and/or information in a network environment.

I/O interface(s) 2014 allow for input and output of data and/or information with other entities that may be connected to computer device 2000. For example, I/O interface(s) 2014 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 2020 can include instructions that, when executed, cause processor(s) 2002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 2020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 2004 and/or storage 2006 can store data, software, code, instructions (e.g., processor instructions), logic, parameters, combinations thereof, and/or the like used for operations described herein. This includes memory element(s) 2004 and/or storage 2006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A lidar apparatus comprising:
at least one light source configured to provide a light beam; and
a beam steering arrangement configured to scan the light beam up to a first range in a first directional field of view and to scan the light beam up to a second range in a second directional field of view that is perpendicular to the first directional field of view.

2. The lidar apparatus of claim 1, wherein the first directional field of view is a horizontal directional field of view and the first range is 360 degrees, and the second directional field of view is a vertical directional field of view and the second range is approximately 20 degrees.

3. The lidar apparatus of claim 2, wherein the beam steering arrangement includes:
a reflective optical element arranged to reflect the light beam from the at least one light source;
a beam splitter configured to split a reflected light beam from the reflective optical element to produce a plurality of light beams; and
a lens arrangement to receive the plurality of light beams and direct the plurality of light beams spanning the second range in the second directional field of view;
wherein the reflective optical element, the beam splitter and the lens arrangement are mounted to be rotated about an axis substantially perpendicular to the first directional field of view up to the first range to scan the plurality of light beams in the first directional field of view.

4. The lidar apparatus of claim 3, wherein the beam steering arrangement includes:
a reflective optical element having first reflective face and a second reflective face at a right-angle to each other, the first reflective face configured to reflect the light beam from the at least one light source and the second reflective face configured to reflect incoming light;
a first diverse optical element arranged to receive light reflected by the first reflective face to diverge light to create the second directional field of view; and
a second diverse optical element configured to receive incoming light reflected by one or more targets and to direct the incoming light to the second reflective face of the reflective optical element;
wherein the reflective optical element, the first diverse optical element and the second diverse optical element are mounted to be rotated about an axis substantially perpendicular to the first directional field of view up to the first range to scan the plurality of light beams in the first directional field of view.

5. The lidar apparatus of claim 4, wherein the reflective optical element is a right-angle mirror or a prism, and the first diverse optical element and second diverse optical element are an optical lens, diffractive optical element or prism.

6. The lidar apparatus of claim 2, wherein the beam steering arrangement includes:
a polygon mirror having a plurality of faces and configured to receive a light beam from the at least one light source, the polygon mirror arranged to be rotated about a central axis of the polygon mirror to scan the light beam in the vertical directional field of view, and to be rotated about a vertical axis to scan the light beam in the horizontal directional field of view.

7. The lidar apparatus of claim 2, wherein the beam steering arrangement includes:
a polygon mirror having a plurality of faces, the polygon mirror arranged to be rotated about a vertical axis to scan light beams in the horizontal directional field of view;
a splitter and circulator arrangement configured to receive the light beam from the at least one light source to split the light beam according to a beam splitting ratio to generate multiple output beams; and
a lens arrangement configured to receive the multiple output beams to launch multiple propagated light beams at different angles so that the multiple propagated light beams span the second range of the vertical directional field of view, towards the polygon mirror.

8. The lidar apparatus of claim 7, wherein the polygon mirror is an irregular polygon mirror, and wherein the plurality of faces of the polygon mirror is are tilted by a predetermined amount.

9. The lidar apparatus of claim 7, wherein the splitter and circulator arrangement includes a waveguide and/or fiber array configured to generate the multiple output beams from the light beam.

10. The lidar apparatus of claim 9, wherein the splitter and circulator arrangement includes:
a splitter configured to receive the light beam from the at least one light source and split the light beam;
a phase modulator configured to receive at least a portion of the light beam split by the splitter, the phase modulator configured to phase modulate the portion of the light beam split by the splitter to output a phase modulated split beam;
a fiber amplifier configured to receive and amplify the phase modulated split beam and to output an amplified phase modulated split beam;
a plane light-wave circuit splitter configured to divide the amplified phase modulated split beam into multiple beams; and
an independent circulator arrangement configured to route the multiple beams to a fiber channel/physical contact connector that couples the multiple beams to individual waveguides or fibers of the waveguide and/or fiber array.

11. The lidar apparatus of claim 10, wherein the lens arrangement comprises a single lens or a combination of multiple lenses configured to collimate different light beams output by the waveguide and/or fiber array, the multiple lenses aligned such that each of the multiple output beams passes through all of the multiple lenses.

12. The lidar apparatus of claim 11, wherein the multiple lenses includes at least a first lens and a second lens, wherein the first lens and the second lens are bonded together such that there is no air gap between them, or the first lens and the second lens are separated by an air gap.

13. The lidar apparatus of claim 2, wherein the beam steering arrangement includes:
a galvanometer mirror configured receive the light beam from the at least one light source and to be rotated about a center horizontal axis to scan the light beam in the vertical directional field of view; and
a polygon mirror configured to receive a reflected light beam from the galvanometer mirror and configured to be rotated about a center vertical axis to scan the light beam in the horizontal directional field of view.

14. The lidar apparatus of claim 2, further comprising a plurality of beam steering arrangements each configured to scan in overlapping or non-overlapping portions of 360 degrees in the horizontal directional field of view.

15. A lidar apparatus comprising:
at least one light source configured to provide a light beam;
a splitter and circulator arrangement configured to receive the light beam from the at least one light source to split the light beam according to a beam splitting ratio to generate multiple output beams; and
a lens arrangement configured to receive the multiple output beams to launch multiple propagated light beams at different angles so that the multiple propagated light beams span a range of a vertical directional field of view.

16. The lidar apparatus of claim 15, wherein the splitter and circulator arrangement includes a waveguide and/or fiber array configured to generate the multiple output beams from the light beam.

17. The lidar apparatus of claim 16, wherein the splitter and circulator arrangement includes:
a splitter configured to receive the light beam from the at least one light source and split the light beam into multiple light beams;
a phase modulator configured to receive one light beam of the multiple light beams split by the splitter, the phase modulator configured to phase modulate h the one light beam split by the splitter to output a phase modulated split beam;
a fiber amplifier configured to receive and amplify the phase modulated split beam and to output an amplified phase modulated split beam;
a plane light-wave circuit splitter configured to divide the amplified phase modulated split beam into multiple beams; and
an independent circulator arrangement configured to route the multiple beams to a fiber channel/physical contact connector that couples the multiple beams to individual waveguides or fibers of the waveguide and/or fiber array.

18. The lidar apparatus of claim 16, wherein the splitter and circulator arrangement includes:
a first splitter configured to split the light beam into a first light beam and a second light beam;
an electro-optical modulator configured to receive the first light beam and modulate the first light beam to produce a modulated light beam;
an optical amplifier configured to amplify the modulated light beam to produce an amplified modulated light beam;
a second splitter configured to split the amplified modulated light beam into a plurality of amplified modulated light beams; and
a bank of independent circulators configured to route the plurality of amplified modulated light beams to waveguides or fibers of a waveguide and/or fiber array, which in turn direct the plurality of amplified modulated light beams to the lens arrangement.

19. The lidar apparatus of claim 18, wherein the lens arrangement comprises a single lens or a combination of multiple lenses configured to collimate different light beams output by the waveguide and/or fiber array, the multiple lenses aligned such that each of the multiple output beams passes through all of the multiple lenses.

20. The lidar apparatus of claim 18, further comprising:
a polygon mirror having a plurality of faces, the polygon mirror arranged to be rotated about a vertical axis and to receive the multiple propagated light beams output by the lens arrangement to scan the multiple propagated light beams in a horizontal directional field of view.

21. A method for scanning a light beam in a lidar system, the method comprising:
obtaining a light beam from a light source;
modulating the light beam to produce a modulated light beam;
scanning the modulated light beam up to a first range in a first directional field of view and up to a second range in a second directional field of view that is perpendicular to the first directional field of view; and
capturing reflected light along the first directional field of view and the second directional field of view.

22. The method of claim 21, wherein the first directional field of view is a horizontal directional field of view and the first range is 360 degrees, and the second directional field of view is a vertical directional field of view and the second range is approximately 20 degrees.

23. The method of claim 22, wherein scanning comprises:
splitting the light beam from the light source with a beam splitter to produce a plurality of light beams;
directing the plurality of light beams with a lens arrangement to span the second range in the second directional field of view; and
rotating the beam splitter and the lens arrangement about an axis substantially perpendicular to the first directional field of view up to the first range to scan the plurality of light beams in the first directional field of view.

24. The method of claim 22, wherein scanning comprises:
splitting the light beam;
phase modulating a portion of the light beam split by the splitting to provide a phase modulated split beam;
amplifying the phase modulated split beam and to provide an amplified phase modulated split beam;
dividing the amplified phase modulated split beam into multiple beams; and
routing the multiple beams to individual waveguides or fibers of a waveguide and/or fiber array.

25. The method of claim 22, where scanning comprises:
rotating a galvanometer mirror about a center horizontal axis to scan the light beam in the vertical directional field of view;
receiving at a polygon mirror a reflected light beam from the galvanometer mirror; and
rotating the polygon mirror about a center vertical axis to scan the light beam in the horizontal directional field of view.
